(19) United States
(12) Patent Application Publication
(10) Pub. No.: US 2026/0034548 A1
(43) Pub. Date: Feb. 5, 2026

(54) DISPOSAL TOOL

(71) Applicant: Jeffrey William Hallmark, Franklin, NC (US)

(72) Inventor: Jeffrey William Hallmark, Franklin, NC (US)

(21) Appl. No.: 18/794,033

(22) Filed: Aug. 5, 2024

(51) Int. Cl. B02C 23/04

(52) U.S. Cl. CPC B02C 23/04

(57) ABSTRACT

A utensil includes a handle including a flared surface extending radially outward from a first handle surface. The utensil further includes a tool head coupled to the handle, the tool head including a first tool head surface extending radially inward and longitudinally away from the flared surface of the handle, an interface between the first tool head surface and the flared surface defining a maximum diameter of the utensil. The tool head further includes a tip disposed on a distal end of the first tool head surface, the tip including (i) a first tip surface extending radially outward from the distal end of the first tool head surface, and (ii) a base tip surface extending perpendicular to the longitudinal axis. The tool head further includes a plurality of ridges protruding from the first tool head surface.

### BACKGROUND

A common problem in kitchen environments is the accumulation of food waste in the kitchen sink (or other areas having a drain). For example, throughout the course of washing and rinsing dishes in a kitchen sink, food waste may accumulate on the sides and on the base of the sink-rather than flowing down the drain. Food waste also may accumulate around the drain and on the drain structure itself, causing a backup of food waste upstream from the drain.

A user is often forced to remove the food waste manually. This may include picking the food waste out of the sink/drain or pushing the food waste down the drain and into an attached garbage disposal. A user may be forced to use another nearby utensil (e.g., a fork) to push the food into the garbage disposal, or they may use their hand—an undesirable solution from an efficiency and hygienic standpoint.

Therefore, a need exists for systems and devices to facilitate the removal of food waste from a kitchen sink.

### SUMMARY

One implementation of the present disclosure is a utensil including a handle and a tool head. The handle includes a proximal end and a distal end spaced apart from the proximal end along a longitudinal axis of the utensil, the distal end including a flared surface extending radially outward from a first handle surface of the handle. The tool head is coupled to the handle. The tool head includes a first tool head surface extending radially inward and longitudinally away from the flared surface of the handle, an interface between the first tool head surface and the flared surface defining a maximum diameter of the utensil. The tool head includes a tip disposed on a distal end of the first tool head surface, the tip including (i) a first tip surface extending radially outward from the distal end of the first tool head surface, and (ii) a base tip surface extending perpendicular to the longitudinal axis. The tool head includes a plurality of ridges protruding from the first tool head surface.

In some implementations, the plurality of ridges protrudes normal to the first tool head surface.

In some implementations, the plurality of ridges includes a first ridge and a second ridge, each of the first ridge and the second ridge being spaced apart from each other in a longitudinal direction parallel to the longitudinal axis of the utensil.

In some implementations, the plurality of ridges forms a plurality of rings extending circumferentially around the first tool head surface about the longitudinal axis of the utensil.

In some implementations, the tool head is integrally formed with the utensil.

In some implementations, the first tool head surface forms a substantially conical shape of the tool head.

In some implementations, the proximal end of the handle includes a bulb extending radially outward from the first handle surface, wherein a bulbous surface of the bulb and the flared surface of the handle together define the first handle surface disposed therebetween.

In some implementations, the utensil is rotationally symmetric about the longitudinal axis.

In some implementations, the tip further includes a second tip surface extending between the first tip surface and the base tip surface, the second tip surface being substantially parallel to the longitudinal axis of the utensil.

In some implementations, the utensil is 3D printed

In some implementations, an interior chamber of the tool head is at least partially defined by the first tool head surface and the base tip surface.

In some implementations, the interior chamber is at least partially solid adjacent the tip of the tool head.

In some implementations, the interior chamber is at least partially hollow, and a wall thickness of the utensil is in the range of 0.1 to 0.5 inches (e.g., 0.2 inches).

In some implementations, an angle between the first handle surface and the flared surface is in the range of 90 to 179 degrees (e.g., 134 degrees).

In some implementations, an angle between the flared surface and the first tool head surface is in the range of 45 to 179 degrees (e.g., 110 degrees).

In some implementations, an angle between the first tool head surface and the first tip surface is in the range of 45 to 179 degrees (e.g., 110 degrees).

In some implementations, the maximum diameter of the utensil is in the range of 2.5 to 6.5 inches (e.g., 4 inches).

In some implementations, the utensil is sized and configured to push food waste down a drain of a sink.

In some implementations, the plurality of ridges is configured to capture and move food waste in a sink.

In some implementations, the tip of the tool head is configured to fit down a drain of a sink, and the flared surface of the handle is configured not to fit down the drain of a sink.

According to another implementation, a system is disclosed including a utensil as described herein.

According to another implementation, a method of manufacturing a utensil as described herein is disclosed.

According to another implementation, a method of cleaning a sink with a utensil as described herein is disclosed.

The device is explained in even greater detail in the following drawings. The drawings are merely exemplary and certain features may be used singularly or in combination with other features. The drawings are not necessarily drawn to scale.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1 is a side view of a utensil, according to one implementation.

FIG. 2 is an isometric view of the utensil of FIG. 1.

FIG. 3 is a top view of the utensil of FIG. 1.

FIG. 4 is a bottom view of the utensil of FIG. 1.

FIG. 5 is a cross-sectional view of the utensil of FIG. 1.

FIG. 6 is an engineering drawing on a utensil, according to one implementation.

FIG. 7 is a diagram of a drain system including a utensil, according to one implementation.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Referring generally to the figures, a utensil is shown, according to various implementations.

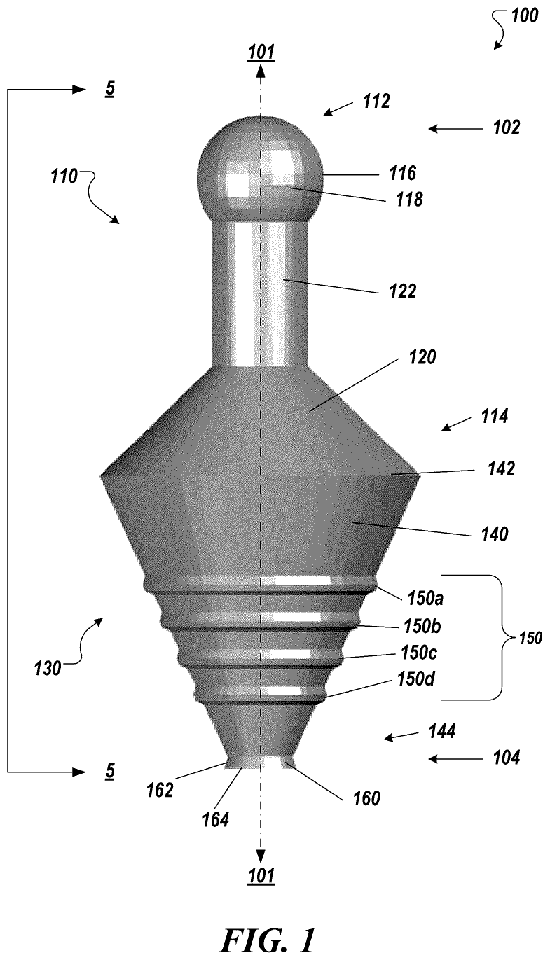

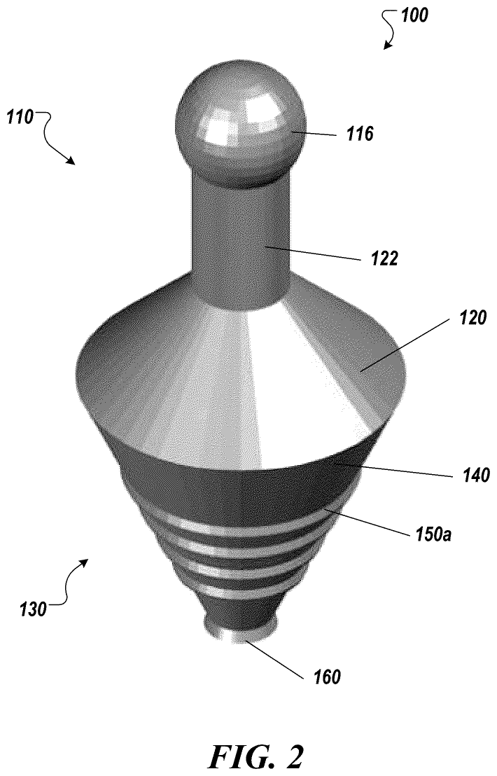

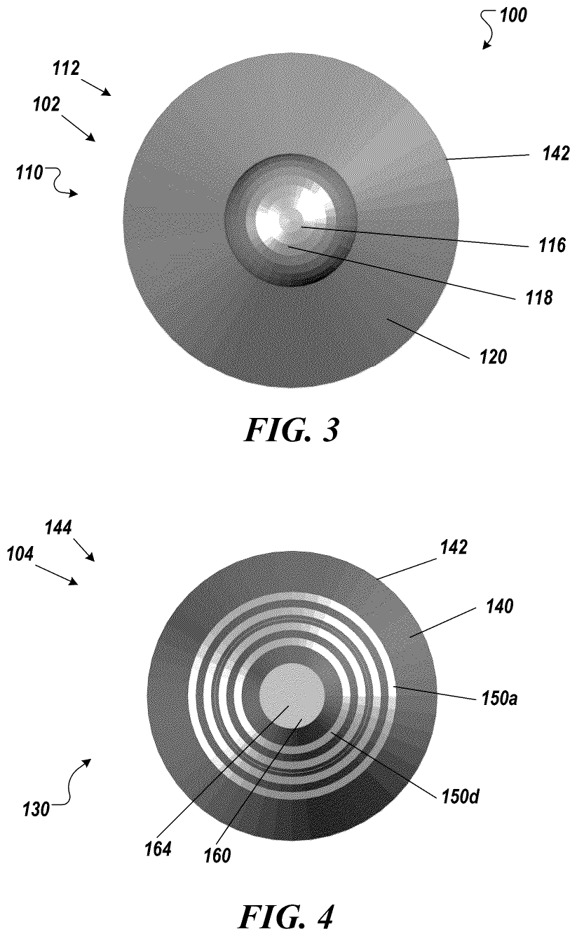

FIG. 1 shows a utensil 100, according to one implementation. FIG. 2 shows an isometric view of the utensil 100 of FIG. 1, FIG. 3 shows an associated top view, and FIG. 4 shows an associated bottom view. The utensil 100 may be used to facilitate moving waste (e.g., food waste) into a drainage system (e.g., a drain in the bottom of a kitchen sink attached to a garbage disposal). The utensil 100 may facilitate safe and hygienic movement of food waste into the drain and garbage disposal due at least to the structural features and the geometry of the utensil 100.

The utensil 100 may be manufactured from and include a waterproof plastic material (e.g., a plastic material that can be easily cleaned and sanitized). In some implementations, the utensil 100 is at least partially or entirely 3D printed. In other implementations, the utensil 100 includes metal, wood, rubber, or other common rigid or semi-rigid materials. In other implementations, the utensil 100 is formed from other manufacturing processes (e.g., molding, injection molding, casting, or machining).

The utensil 100 includes a proximal end or a first end 102 and a distal end or a second end 104. The second end 104 is opposite and spaced apart from the first end 102 along a longitudinal axis 101.

The utensil 100 includes a handle 110 and a tool head 130. The tool head 130 is coupled to the handle 110 and disposed on the second end 104 of the utensil 100. The tool head 130 is integrally formed with the handle 110. However, in other implementations, the tool head may be a separate part coupled to or detachable from the handle.

The utensil 100, including both the handle 110 and the tool head 130, are rotationally symmetrical about the longitudinal axis 101. However, in other implementations, the utensil may have partial rotational symmetry (e.g., 180 degrees about the longitudinal axis). In other implementations, one of the handle and the tool head may be rotationally symmetrical while the other of the tool head and the handle is not rotationally symmetrical.

The handle 110 is disposed on the first end 102 of the utensil 100. The handle 110 includes a proximal end 112 and a distal end 114 spaced apart from the proximal end 112 along the longitudinal axis 101 of the utensil 100. The proximal end 112 of the handle 110 includes a bulb 116 including a bulbous surface 118. The distal end 114 of the handle 110 includes a flared surface 120. The flared surface 120 of the handle 110 has a frustoconical shape.

A first handle surface 122 is defined between the bulbous surface 118 of the bulb 116 and the flared surface 120. The first handle surface 122 is radially inward from the bulbous surface 118 and the flared surface 120. However, in other implementations, the first handle surface may be at least partially radially aligned with or radially outward from a portion of the bulbous surface and/or the flared surface. In some implementations, the first handle surface includes a gripping surface and/or grooves for a user's hand/fingers.

The tool head 130 coupled to the handle 110 includes a first tool head surface 140, a plurality of ridges 150, and a tip 160. The first tool head surface 140 extends radially inward from, and longitudinally away from, the flared surface 120 of the handle 110. An interface 142 between the flared surface 120 of the handle 110 the first tool head surface 140 defines a maximum diameter of the utensil 100.

The plurality of ridges 150 protrude outward from the first tool head surface 140. For example, the plurality of ridges 150 extend normal to the first tool head surface 140. However, in other implementations, the plurality of ridges extend substantially radially outward with respect to the longitudinal axis 101. In some implementations, the plurality of ridges include a distal-facing surface substantially perpendicular to first tool head surface, the distal-facing surface configured to provide a scraping or collecting surface for each of the plurality of ridges.

The plurality of ridges 150 of the utensil 100 include four ridges 150a, 150b, 150c, and 150d. However, in other implementations, the utensil may include a different number of ridges (e.g., 1, 2, 3, 5, 6, 7, 8, 9, 10, 20, 30, 40, 50, or more ridges). Each of the ridges 150a-150d are spaced apart from each other in a longitudinal direction along the first tool head surface 140 (e.g., in a direction parallel to the longitudinal axis 101 of the 100). Each of the ridges 150a-150d forms a ring extending circumferentially around the first tool head surface 140 about the longitudinal axis 101. In other implementations, the tool head may include a different pattern of scraping structures or ridges (e.g., a plurality of ridges adjacent to each other without a space in between, a pattern of offset rings on a diagonal with respect to the longitudinal axis, a checkerboard pattern of protrusions, a pattern of dot-like or hemispherical protrusions, or any other ridged or non-smooth surface capable of scraping food waste along the surface of a sink).

The tip 160 is disposed on a distal end 144 of the first tool head surface 140 and the second end 104 of the utensil 100. The tip 160 includes a first tip surface 162 extending radially outward from the distal end 144 of the first tool head surface 140. The tip 160 further includes a base tip surface 164 extending perpendicular to the longitudinal axis 101. The base tip surface 164 of the utensil 100 is coaxial with the longitudinal axis 101. However, in other implementations, the base tip surface may be partially offset from coaxial the longitudinal axis and/or partially offset from perpendicular to the longitudinal axis.

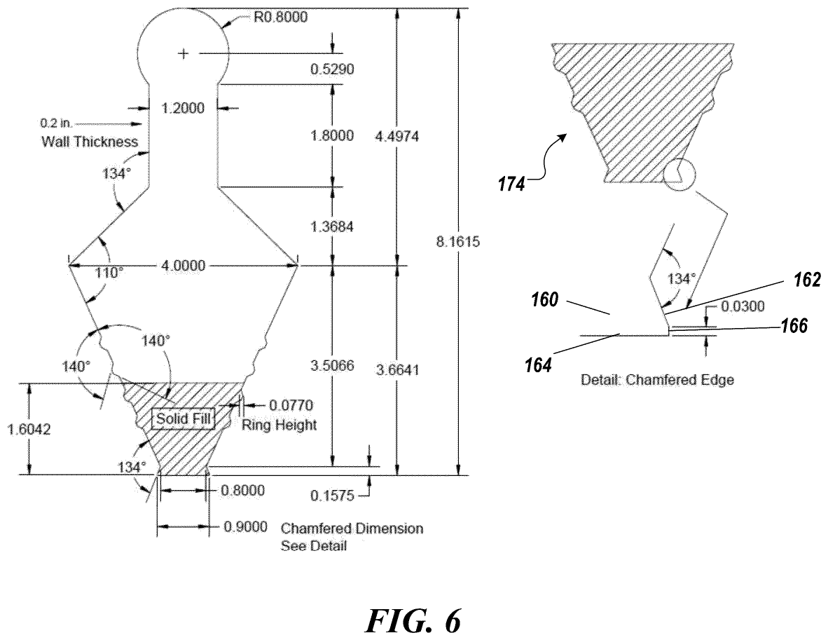

As shown in more detail in FIG. 6, the tip 160 further includes a second tip surface 166 extending between the first tip surface 162 and the base tip surface 164. The second tip surface 166 is substantially parallel to the longitudinal axis 101 of the utensil 100. In some implementations, the second tip surface 166 is a chamfered edge of the tip 160.

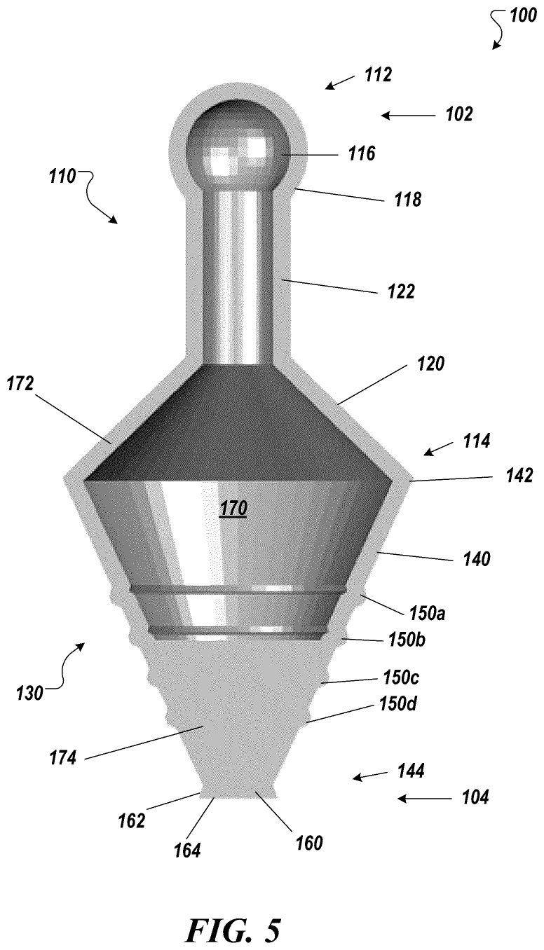

As shown in the cross-section of FIG. 5 along line 5-5 in FIG. 1, the utensil 100 includes an interior chamber 170 defined by the outer wall 172 of the utensil 100. The outer wall 172 may include at least a portion of the first tool head surface 140 and the handle 110 (e.g., a portion of each of the flared surface 120 and the first tool head surface 140). As shown, the handle 110 is entirely hollow. However, in other implementations, the handle is at least partially solid. In other implementations, the utensil 100 is entirely solid without an interior chamber.

A solid tip portion 174 is adjacent to the tip 160 of the utensil 100. The solid tip portion 174 at least partially defines the distal end of the interior chamber 170. The solid tip portion 174 provides weight distribution, rigidity, and/or durability to the second end 104 of the utensil 100.

FIG. 6 shows an engineering diagram including a cross-sectional view of the utensil 100 and a detail view of the solid tip portion 174 and the tip 160 of the tool head 130. The dimensions shown in FIG. 6 (in inches and degrees) are exemplary only and do not limit the scope of the disclosure.

As shown, the maximum diameter of the utensil 100 at the interface 142 is 4 inches. However, in other implementations, the maximum diameter is in the range of 2 to 10 inches (e.g., 2, 3, 4, 5, 6, 7, 8, 9, or 10 inches in diameter). In other implementations, the utensil is sized to fit partially within a drain (e.g., having a maximum diameter that prevents the utensil from entering the drain).

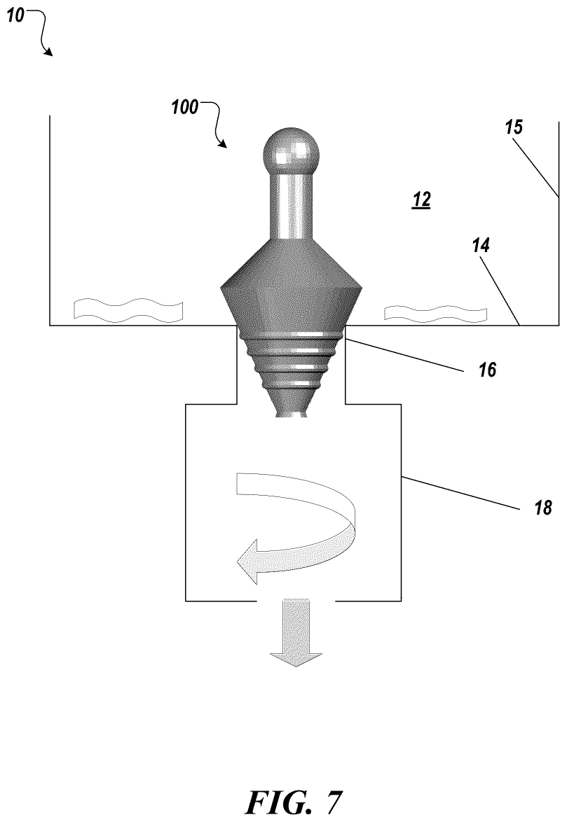

FIG. 7 shows a system 10 utilizing the utensil 100, according to one implementation. In use, the utensil 100 is provided for moving and scraping food waste into a drain 16 of the system 10. The drain 16 is defined by a bottom surface 14 of a sink 12. In one example, throughout the process of washing and rinsing dishes, food waste accumulates along the bottom surface 14 (or a side surface 15) of the sink 12.

Rather than using their hand, a user can grasp the utensil 100 by the handle 110 and scrape the food waste with the tool head 130. The plurality of ridges 150 on the tool head 130 facilitate grabbing and moving food from the bottom surface 14 and/or side surface 15 of the sink 12 and into the drain 16.

The utensil 100 is sized and angled such that the tool head 130 and the tip 160 thereof fit into the drain 16 but do not interfere with the garbage disposal 18 coupled thereto. For example, the garbage disposal 18 includes spinning and cutting elements configured to break down the food waste into smaller pieces to be drained into a sewer or septic system. However, it is undesirable to stick traditional kitchen utensils, or a user's hand, into the drain 16 and the associated garbage disposal 18. Therefore, the shape of the utensil 100 is advantageous because it can extend far enough into the drain 16 and the garbage disposal 18 to adequately deposit food waste without interfering with the mechanical elements of the garbage disposal 18.

The disclosed utensil, and variations thereof, is capable of hygienically and efficiently cleaning out food waste from a sink and into a drainage system (e.g., including a garbage disposal). The disclosed utensil can be easily cleaned and reused. The disclosed utensil limits or eliminates the risk associated with user's being injured by a garbage disposal. The disclosed utensil further limits the bacterial and other contamination risks associated with touching food waste.

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

What is claimed is:

1. A utensil comprising:
a handle comprising a proximal end and a distal end spaced apart from the proximal end along a longitudinal axis of the utensil, the distal end including a flared surface extending radially outward from a first handle surface of the handle; and
a tool head coupled to the handle, the tool head comprising:
a first tool head surface extending radially inward and longitudinally away from the flared surface of the handle, an interface between the first tool head surface and the flared surface defining a maximum diameter of the utensil;
a tip disposed on a distal end of the first tool head surface, the tip comprising (i) a first tip surface extending radially outward from the distal end of the first tool head surface, and (ii) a base tip surface extending perpendicular to the longitudinal axis; and
a plurality of ridges protruding from the first tool head surface.

2. The utensil of claim 1, wherein the plurality of ridges protrudes normal to the first tool head surface.

3. The utensil of claim 1, wherein the plurality of ridges comprises a first ridge and a second ridge, each of the first ridge and the second ridge being spaced apart from each other in a longitudinal direction parallel to the longitudinal axis of the utensil.

4. The utensil of claim 1, wherein the plurality of ridges forms a plurality of rings extending circumferentially around the first tool head surface about the longitudinal axis of the utensil.

5. The utensil of claim 1, wherein the tool head is integrally formed with the utensil.

6. The utensil of claim 1, wherein the first tool head surface forms a substantially conical shape of the tool head.

7. The utensil of claim 1, wherein the proximal end of the handle comprises a bulb extending radially outward from the first handle surface, wherein a bulbous surface of the bulb and the flared surface of the handle together define the first handle surface disposed therebetween.

8. The utensil of claim 1, wherein the utensil is rotationally symmetric about the longitudinal axis.

9. The utensil of claim 1, wherein the tip further comprises a second tip surface extending between the first tip surface and the base tip surface, the second tip surface being substantially parallel to the longitudinal axis of the utensil.

10. The utensil of claim 1, wherein the utensil is 3D printed.

11. The utensil of claim 1, wherein an interior chamber of the tool head is at least partially defined by the first tool head surface and the base tip surface.

12. The utensil of claim 11, wherein the interior chamber is at least partially solid adjacent the tip of the tool head.

13. The utensil of claim 11, wherein the interior chamber is at least partially hollow, and a wall thickness of the utensil is in a range of 0.1 to 0.5 inches.

14. The utensil of claim 1, wherein an angle between the first handle surface and the flared surface is in a range of 90 to 179 degrees.

15. The utensil of claim 1, wherein an angle between the flared surface and the first tool head surface is in a range of 45 to 179 degrees.

16. The utensil of claim 1, wherein an angle between the first tool head surface and the first tip surface is in a range of 45 to 179 degrees.

17. The utensil of claim 1, wherein the maximum diameter of the utensil is in a range of 2.5 to 6.5 inches.

18. The utensil of claim 1, wherein the utensil is sized and configured to push food waste down a drain of a sink.

19. The utensil of claim 1, wherein the plurality of ridges is configured to capture and move food waste in a sink.

20. The utensil of claim 1, wherein the tip of the tool head is configured to fit down a drain of a sink, and the flared surface of the handle is configured not to fit down the drain of the sink.
